(19) United States
(12) Patent Application Publication
(10) Pub. No.: US 2016/0044058 A1
(43) Pub. Date: Feb. 11, 2016

(54) MANAGING SECURITY OF ENDPOINTS OF A NETWORK

(71) Applicant: Jeffrey Craig Schlauder, Fairhope, AL (US)

(72) Inventor: Jeffrey Craig Schlauder, Fairhope, AL (US)

(21) Appl. No.: 14/822,364

(22) Filed: Aug. 10, 2015

Related U.S. Application Data
(60) Provisional application No. 62/034,877, filed on Aug. 8, 2014.

(51) Int. Cl. H04L 29/06

(52) U.S. Cl. CPC H04L 63/1433

(57) ABSTRACT

Disclosed are various embodiments for analyzing endpoints of a network, including determining security statuses for clients on the network. A recommendation may be made for the clients from the determined security statuses. A user interface may be generated to provide a user with the recommendation. The user interface may include a summary of the security statuses for the clients.

### CROSS-REFERENCE TO RELATED APPLICATIONS

This application is a non-provisional of, and claims priority to, co-pending U.S. Provisional Application entitled “MANAGING SECURITY OF ENDPOINTS OF A NETWORK,” filed on Aug. 8, 2014, and assigned application No. 62/034,877, which is incorporated herein by reference in its entirety.

### BACKGROUND

A variety of computing devices may be coupled to contemporary home networks. Such devices, also known as network endpoints, may include, for example, laptops, desktops, mobile phones, tablets, electronic book readers, smart televisions, game consoles, and so on. These devices may be susceptible to security vulnerabilities by virtue of being connected to the network. Security vulnerabilities may include exploits of outdated software, viruses, malware, adware, and so on. While users may install anti-virus software on one or more devices, often other devices may be left unprotected. In some cases, the installed anti-virus software is not a comprehensive solution, and the device on which it is installed may remain susceptible to exploits of outdated software, adware, and so on.

### BRIEF DESCRIPTION OF THE DRAWINGS

Many aspects of the present disclosure can be better understood with reference to the following drawings. The components in the drawings are not necessarily to scale, emphasis instead being placed upon clearly illustrating the principles of the disclosure. Moreover, in the drawings, like reference numerals designate corresponding parts throughout the several views.

FIG. 1 is an illustration of a networked environment according to various embodiments of the present disclosure.

FIGS. 2-4 are drawings of examples of user interfaces rendered by a client in the networked environment of FIG. 1 according to various embodiments of the present disclosure.

FIG. 5 is a flowchart illustrating one example of functionality implemented as a portion of an endpoint analysis engine executed in a computing device in the networked environment of FIG. 1 according to various embodiments of the present disclosure.

FIG. 6 is a schematic block diagram that provides one example illustration of a computing device employed in the networked environment of FIG. 1 according to various embodiments of the present disclosure.

### DETAILED DESCRIPTION

The present disclosure relates to approaches for managing security of endpoints of a network by providing a comprehensive view of the current security status of each endpoint, along with providing prioritized recommendations for solutions to security issues. Today, a majority of consumers have multiple computing devices—laptops, computers, phones, etc. Households, therefore, are comprised of a myriad of different devices and their corresponding technologies, each of which has its own security implications. Consumers today tend to take an ad-hoc approach to managing the security (anti-virus, anti-malware, anti-adware, automatic updates and security patches) components of each device, known as endpoint security.

For example, assume that one consumer in a household buys a laptop that comes with a 90-day subscription to one anti-virus solution (e.g., NORTON). After 90 days, the consumer may subscribe to that solution for $50 per year. Assume that another consumer in the same household buys a tablet that comes with a competing solution (e.g., MCAFEE) for another $50 per year. As this scenario plays out across the household, multiple devices become configured with different security solutions, each with varying functionality, levels of protection, prices, renewal periods, and so on. There is no centralized management, transparency, or visibility into the current state of all networked devices within a household, small business, or other networked environment, leaving the consumers vulnerable to common preventable attacks, and/or potentially overpaying for what may be overlapping and/or insufficient levels of protection.

Consider the following scenario: Assume that a household has ten networked devices—two tablets, four personal computers (PCs), and four smartphones. Embodiments described herein may run a diagnostic analysis and find that three of the four PCs have NORTON, but one PC has no anti-virus protection. The two tablets may be determined to have MCAFEE, but the four smartphones may be determined to have no security solution installed. Further, it may be discovered that two of the PCs and one of the tablets have “automatic updates” disabled, two of the four smartphones are “rooted,” and one smartphone has a known malicious application installed. Additionally, it may be estimated that this household is paying $100/year to cover the MCAFEE installation on the two tablets, and $120/year to cover the NORTON installation on the three PCs. Thus, the household is essentially paying $220/year to cover half of its devices, leaving the other half vulnerable.

Embodiments of the present disclosure may deliver an on-demand and/or scheduled diagnostic analysis of the household's network with the output of the analysis being a report, along with a prioritized list of remediation items based on a specific profile. The report may be an analysis of the current state of the network, including risks, vulnerabilities, coverage gaps, etc. This list may describe the items the consumer can address immediately, such as activating automatic updates, along with endpoint solution recommendations for which embodiments of the present disclosure may provide guidance and pricing options. Simultaneously, embodiments of the present disclosure may take this profile to the marketplace through a prioritized bidding approach (e.g., existing presence first, then open market) to deliver cost-effective, comprehensive coverage options back to the household. The current operators in the household, NORTON and MCAFEE, then may have the opportunity to bid on covering all the devices in the household.

Thus, embodiments of the present disclosure may centralize the management of endpoint security solutions on networked devices within a household, small business, or other small networked environment, allowing the consumer transparency and visibility to make informed and cost-appropriate choices about how to secure and manage networked devices based on specific device profiles and current subscriptions. Embodiments may consult a marketplace for bidding on recommended endpoint solutions. In one instance, first priority is given to the entities that already have a presence in the household, then to other entities in the industry. The ultimate goal being bringing the most cost-effective, comprehensive managed solution to the consumers within a networked household.

In one deployment, the solution will be offered free of charge to consumers, through a website, a mobile application, and/or a household console such as a home automation system. Revenues may be generated from the reseller relationship with the endpoint solution providers. Accordingly, the consumer is provided with a more cost-effective, comprehensive level of protection. In addition to options provided by third parties for a fee or subscription, one or more free options for security may be provided for the household. As this technology is deployed, the major competitors in the endpoint security market may have to lower prices in order to win the household and amass market share.

The system may be deployed via an endpoint analysis engine. In one implementation, the endpoint analysis engine may be executed as an application upon a client device, such as a smartphone or a laptop. In another implementation, the endpoint analysis engine may be integrated into a home or office router, and may provide a web-based interface. In still another implementation, the endpoint analysis engine may be hosted and managed as a cloud-based system, accessible via the Internet. In such an implementation, a user may interact with the endpoint analysis engine via a web browser or specific application.

In order for the endpoint analysis engine to analyze the state of the devices coupled to the network, the client devices may be specially configured to publish information to the endpoint analysis engine. For example, a service may be installed on each device to scan the device and report the security status to the endpoint analysis engine. Alternatively, permissions on the device may be configured to allow the endpoint analysis engine to scan the device and determine the security status.

The scanning on each device may involve inspection of the device registry and/or scanning of the file system. For example, the endpoint analysis engine may seek to determine: the status of automatic updates for the operating system and/or installed applications, whether known malware is installed, whether security solutions are installed and their respective update status and/or subscription status, and so on. Such security solutions may include comprehensive security solutions, anti-virus software, anti-adware software, anti-malware software, firewall software, and so on. Commercially available solutions may include NORTON, MCAFEE, MICROSOFT SECURITY ESSENTIALS, and so on. In some cases, the endpoint analysis engine may determine the subscription status of an installed solution, which may include a price paid, a next renewal price, a current term, a next renewal term, and so on. In some cases, the endpoint analysis engine may determine that a security solution has expired, which may correspond to being disabled or no longer being updated.

Ultimately, the endpoint analysis engine may generate a user interface providing a dashboard view of the security status of each device on the network. The dashboard view may provide various indicia of risk scores for the network, e.g., low risk, high risk, etc. In one embodiment, the dashboard may enable configuration of various options for the endpoint analysis engine. For example, the options may enable or disable detecting whether devices have been rooted, whether automatic updates are enabled, and/or other features. Further, the options may facilitate creation of a scanning profile for the endpoint analysis engine to scan for various types of predetermined content. In addition to viruses and other malware, users may designate content relating, for example, to pornography, weapons, violence, hate speech, and so on, as scanning targets. Applications, cookies, and other data upon the devices may be scanned for the presence of such targets. When such targets are detected, the consumer may be notified via the dashboard view, and the detected targets may be deleted, quarantined, and/or other actions may be performed. In one embodiment, the presence of selected types of predetermined content may be used in computing the risk scores.

The dashboard view may have recommendations for remedial actions to secure the endpoint devices. These recommendations may be prioritized based on importance, ease of implementation, and/or other factors. In some cases, the recommendations may be for manual actions to be taken. In other cases, the recommendations may be accompanied by user interface components that, when selected, facilitate applying an automated action to one or more devices. Such actions may include turning on automatic updates, installing an anti-virus solution, and so on. In some cases, an action may be manually performed, but an option may be provided for the consumer to purchase remote support to perform the action. For example, a user interface component may be rendered that, when selected, facilitates paying an outside service an amount of money to log in to one or more affected devices and perform remedial actions (e.g., removing a virus that cannot be removed automatically).

In making recommendations for remedial actions, the recommendations may be accompanied by costs. For example, installing or renewing a subscription for a particular anti-virus suite may be associated with a certain cost. The endpoint analysis engine may communicate with providers of solutions to determine the various costs and terms. Thus, a marketplace may be established, and the solution providers may offer competitive bids. The endpoint analysis engine may be configured to recommend the most competitive solution price-wise and/or present the prices for competing solutions. An application programming interface (API) may be published, and the endpoint analysis engine may communicate with various solution providers via the API to determine costs and terms. Alternatively, the various solution providers may push data describing costs and terms to a centralized server for the endpoint analysis engine, which can then serve up the costs and/or terms.

The various solution providers may offer competitive pricing based upon the number of devices that require a solution, the types of solutions already installed, potential install base to be gained or lost, and/or on other factors. By bidding on the entirety of the household's devices, better prices and terms may be offered to the consumer than when looking at a single device subscription alone. Further, a competitor may wish to quickly increase its install base and may offer very good terms for a home network having, say, at least five devices. Alternatively, a competitor may offer favorable terms in order to divest installations of another solution.

The dashboard interface may allow the consumer to compare the offers and make a determination as to what is most favorable. For example, a consumer may prefer to have a solution that would work on all of the household's devices, even if more expensive than having to rely upon two different solutions. In some cases, free solutions may be offered via the dashboard. It may be the case, however, that the free solutions are not as comprehensive as the paid solutions, and/or the free solutions may not function across all devices. The dashboard may include indicia of ratings, reviews, feature sets, and so on in order to enable a consumer to make an informed decision.

In one implementation, the endpoint analysis engine may offer consumers an ability to trade in current installations/subscriptions for discounts applied to renewals of existing solutions or installations of new solutions. If permitted, the endpoint analysis engine may facilitate a trading marketplace where unused portions of subscriptions are sold. For example, if a consumer has a first solution installed on one computer but then decides to install a second solution on all computers for uniformity and for a discount, the consumer may be able to sell the license to the first solution to another consumer via a marketplace offered via the endpoint analysis engine.

It is recognized that effective negotiation with solution providers may lead to a limit on the total number of devices to prevent unauthorized bundling by multiple households, large organizations, etc. For example, a limit of 25 devices may be used. In other cases, no limit may be configured. In some cases, terms of service may limit usage to a single household, a small business, and/or other specific entities.

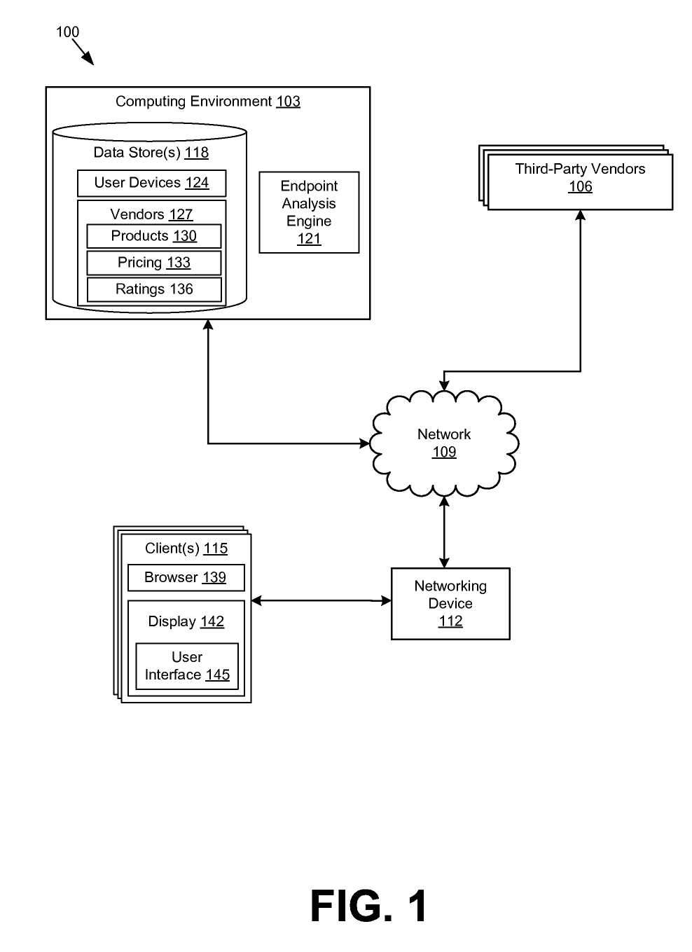

With regard to FIG. 1, shown is an example embodiment of a networked environment 100 according to various embodiments. The networked environment 100 may include a computing environment 103, one or more third-party vendors 106, a network 109, a networking device 112, and one or more clients 115. The computing environment 103 may include a data store 118 and an endpoint analysis engine 121. The endpoint analysis engine 121 may also be executed by the networking device 112 and/or the one or more clients 115. The endpoint analysis engine 121 may be executed as a local application, run as a web server, and/or be executed in some other manner.

The data store 118 may include data regarding user devices 124 and/or vendors 127. The vendor data may include products 130, pricing 133, and ratings 136. The user devices 124 may include information describing the one or more devices 115, such as an IP Address, device name, MAC Address, location, user given name, computer hardware, benchmark results, and/or behavioral characteristics such as a quantity of traffic transmitted and received during a period of time and/or a history of website traffic. The user devices 124 may include information about what applications are installed on each device 115 and a history of security status information including a current security status. The products 130 may include a list of products offered by third-party vendors 106 with a corresponding price being stored in pricing 133. Pricing 133 may include one or more special prices covering one or more collection of products 130. For example, two or more third-party vendors 106 may partner to offer special pricing when goods and services are purchased together, for example, a pricing 133 entry may correspond to a discount for a user buying “Horton” anti-virus with a service package from “Bleak Squad” to install “Horton” anti-virus on one or more clients 115. The ratings 136 may include user ratings and/or critic ratings of one or more of data in vendors 127, products 130, and/or pricing 133. The one or more clients 115 may include a browser 139, a display 142, and a user interface 145. The endpoint analysis engine 121 may be executed on one or more of the clients 115.

The endpoint analysis engine 121 may discover one or more clients 115 connected to the networking device 112 based in part on the one or more clients 115 being connected to the networking device 112. For example, the endpoint analysis engine 121 may transmit a User Datagram Protocol (“UDP”) multicast to all of the one or more clients 115 connected to the networking device 112. The UDP multicast may include an address to respond with a message via the networking device 112, for example, via a Transmission Control Protocol (“TCP”) or a UDP response using the specified address. The networking device 112 may be a household router or switch and each of the one or more clients 115 may be coupled to a household network. The networking device 112 may be a business router in a large or small building and each of the one or more clients 115 may be computers and/or devices for doing business. The networking device 112 may supply a list of connected clients 115 to the endpoint analysis engine 121 from a list of devices currently connected to the networking device 112 and/or a historical or current list of DHCP address assignments. The endpoint analysis engine 121 may use Simple Network Management Protocol (“SNMP”) by querying for one or more management information bases (MIB), or may use some other network status protocol to query devices for a status.

The endpoint analysis engine 121 may determine a security status for each of the one or more clients 115 connected to the networking device 112. For example, the endpoint analysis engine 121 may perform a series of security status checks for each of the one or more clients 115 or may transmit a TCP message to an application executing on a client 115 for each of the one or more clients 115 requesting the client 115 to perform one or more checks and respond with the results. The one or more clients 115 and/or the endpoint analysis engine 121 may determine whether anti-virus software is installed on a client 115, what version of anti-virus software is installed on the client 115, whether the anti-virus software is up-to-date on the client 115, or whether automatic updates of anti-virus software are enabled on the client 115. The client 115 may transmit this information to the endpoint analysis engine 121.

The one or more clients 115 and/or endpoint analysis engine 121 may determine whether operating system updates are enabled, whether a client 115 is infected with a virus, and/or whether the device is rooted. The endpoint analysis engine 121 may determine a security status for the one or more of the clients 115 by polling each of the one or more clients 115 via a network connection. The security status may include one or more of an identification of an installed security solution, a status of a subscription to an installed security solution, whether a client is infected with a virus, whether a security breach has been detected, the status of installing automatic updates, and/or current versions of one or more installed software packages, among other security statuses. The security status may include risks, vulnerabilities, and coverage gaps in the network environment 100.

A client 115 may determine it is infected with a virus by performing a virus scan, by granting remote access to an external device to scan for viruses, or by being notified by a third-party. For example, a client 115 may be notified by a third-party, such a search engine, that malicious data or symptomatic data is being included in network requests originating from the client 115. The endpoint analysis engine 121 may determine that one or more clients 115 are infected with a virus based in part on network traffic originating from the one or more clients 115. The endpoint analysis engine 121 may obtain information regarding the clients 115 via another server. For example, the endpoint analysis engine 121 may query a server providing a user account system, such as an Active Directory server, for information about clients 115 connected to the server, such as anti-virus information or automated update information.

The endpoint analysis engine 121 may determine one or more recommendations based in part on the security status for one or more clients 115. In some embodiments, the one or more recommendations are based in part on the security status of at least two clients 115. The endpoint analysis engine 121 may recommend enabling the installation of automated updates on one or more clients 115 that are determined to have automated updates disabled. The endpoint analysis engine 121 may recommend purchasing a license to an anti-virus program and installing the anti-virus program on one or more clients 115 that are determined not to have anti-virus software installed. The endpoint analysis engine 121 may recommend renewing a subscription to an anti-virus solution currently installed on one or more clients 115.

The endpoint analysis engine 121 may recommend replacing an installed anti-virus solution on one or more clients 115 with a different anti-virus solution. The endpoint analysis engine 121 may recommend replacing the anti-virus solution based in part on features of one or more anti-virus solutions that are available and/or that are currently installed on one of the clients 115. For example, the endpoint analysis engine 121 may recommend installing “McDunfee Pro” for all client devices 115 that currently have “Horton” anti-virus installed based in part on a determination that at least one client 115 has “McDunfee Pro” and/or “McDunfee Pro” is determined to be a better form of anti-virus protection. The endpoint analysis engine 121 may facilitate selling a software license corresponding to the replaced anti-virus solution or offering a discount for trading in the software license corresponding to the replaced anti-virus solution.

The endpoint analysis engine 121 may recommend hiring a contractor to remotely connect to the one or more clients 115 to remove a virus, for example, spyware, and/or to configure the one or more clients 115, for example, uninstalling a current anti-virus and installing a new anti-virus, enabling automated updates, and reverting the rooting of the one or more clients 115. For example, the endpoint analysis engine 121 may receive a request for assistance from a client 115 to install “McDunfee Pro”, facilitate payment from the client 115 for the cost of a license of “McDunfee Pro” and for a fee for a contractor offering computer assistance, initiate a remote desktop connection from the contractor to the client 115, verify successful completion of the installation of “McDunfee Pro,” and initiate payment to the contractor for the services provided.

The endpoint analysis engine 121 may assign a respective priority to each of the one or more recommendations based in part on one or more factors. The factors may include the determined security status, such as the overall security score for each of the one or more clients 115; whether a virus is installed on one of the one or more clients 115; and/or information regarding a discount from a third-party vendor 106. For example, the endpoint analysis engine 121 may assign a higher priority to a recommendation if the cost to implement the recommendation is lower than other recommendations and vice versa.

The endpoint analysis engine 121 may generate a user interface that provides the recommendation and/or a summary of the security statuses for one or more of the clients 115. The endpoint analysis engine 121 may render the user interface on a display 142 when executed on one of the one or more clients 115. The endpoint analysis engine 121 may calculate an overall risk score for each of the one or more clients 115. The user interface may include the overall risk score for each of the one or more clients 115, an indication of whether automatic updates are enabled, disabled, or set to manual for each of the one or more clients 115, the device name for each of the one or more clients 115, a user configured name for each of the one or more clients 115, which anti-virus software is installed on each of the one or more clients 115, and/or other risks that may be determined for each of the one or more clients 115. The user interface may include options to selectively enable scanning of one or more of clients 115 by the endpoint analysis engine 121. The endpoint analysis engine 121 may scan for one or more content types on the one or more devices, such as searching for content illustrating pornography, weapons, violence, hate speech, and so on. The endpoint analysis engine 121 may search website browsing histories on the one or more devices for the one or more content types.

The endpoint analysis engine 121 may determine one or more offers for a security solution from one or more security providers. For example, the endpoint analysis engine 121 may query for, or receive via an API, information describing costs for a variety of security solutions from third-party vendors 106. The information describing costs may be stored in the vendors 127 data base, such as in products 130 and pricing 133. The third-party vendors 106 may customize offers based in part on the current parameters of clients 115, such as offering a discount to uninstall a solution from a competitor and install the solution from one of the third-party vendor 106. The endpoint analysis engine 121 may obtain offers from each of the third-party vendors 106 for a software license to one or more anti-virus solutions and/or to for a service, such as installing a security solution on a client 115. The endpoint analysis engine 121 may obtain the offers in response to a request from a client 115 and/or may store the information in the vendors 127.

The endpoint analysis engine 121 may initiate a task that automates the implementation of a recommendation, such as enabling automatic updates on one or more clients 115, installing an anti-virus solution on one or more clients 115, and/or other implementation of a recommendation. For example, in response to determining that one of the one or more clients 115 does not have “Horton's” installed and receiving a request to install “Horton's” from a user onto the one of the one or more clients 115, the endpoint analysis engine 121 may automatically install “Horton's” on the one of the one or more clients 115.

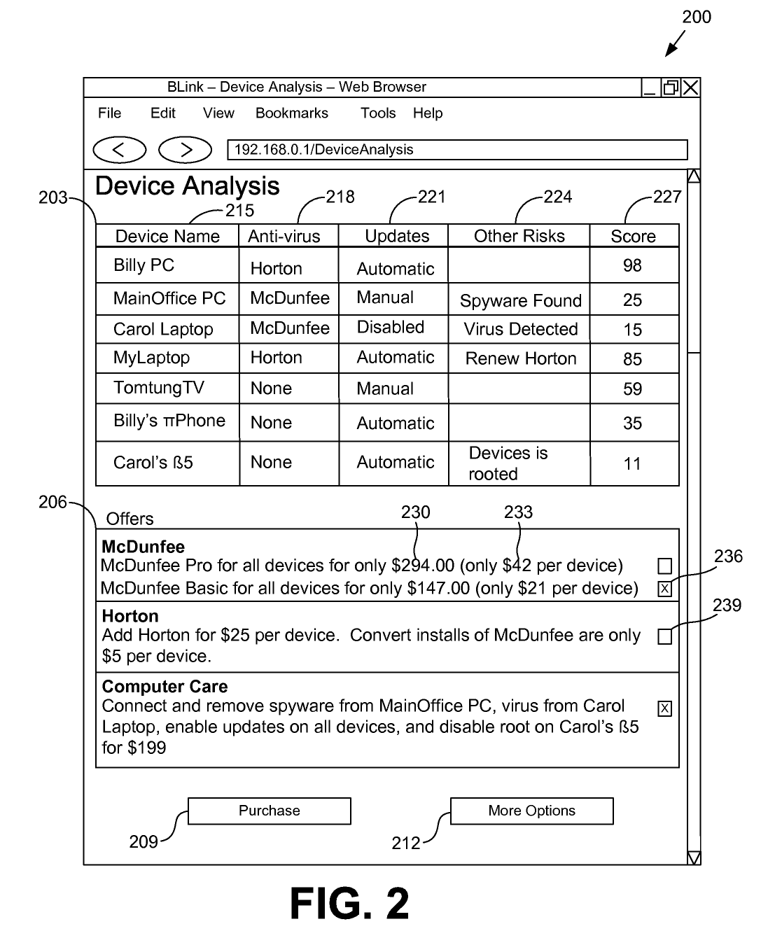

Turning to FIG. 2, shown is an example drawing of a user interface 200 rendered by a client 115 in the networked environment 100 of FIG. 1 according to various embodiments of the present disclosure. The user interface 200 is shown as a web page from a web server on the networking device 112 (FIG. 1), referred to as BLink and assigned the local IP address 192.168.0.1; however, the user interface 200 may be a user interface of a program locally executed on a client 115 (FIG. 1), served from a webserver running on another client 115, or served from an external webserver, such as computing environment 103 (FIG. 1). The user interface 200 may include a summary of security statuses 203, a listing of offers 206, a purchase button 209, and a more options button 212. The summary of security statuses 203 may include information for each of the one or more clients 115 describing device names 215, anti-virus solutions 218, software updates 221, other risks 224, and overall security score 227. Device names 215 may be the computer name for the device or a name entered by a user for the device. The device names 215 for each of the one or more clients 115 may be automatically obtained via one or more network requests.

The anti-virus solutions 218 may include whether an anti-virus solution is installed on the one or more clients 115 and what anti-virus solution is installed when one is determined to be installed. The anti-virus solutions 218 may include a version number for the installed solution and/or a product tier of the installed solution, such as “Horton” Basic, Professional, or Free. The anti-virus solution 218 may include the current version of the installed solution in contrast to the installed version. The software updates 221 may include an indication of whether automatic updates are enabled on the one or more clients 115, whether manual updates are enabled, and/or whether updates are disabled. The software updates 221 may include a current version number for an operating system contrasted to the installed version number of the operating system on one or more clients 115.

The other risks 224 may include a variety of other identified problems and/or potential problems. For example, the other risks 224 may indicate that a virus is detected on a client 115, spyware has been found on a client 115, a client 115 is rooted, and/or a subscription for an anti-virus solution needs to be renewed. The overall security score 227 may include calculated scores for each of the one or more clients 115. The overall security score 227 may be based on a number of factors including, but not limited to, other risks determined, whether automatic updates are installed, whether an anti-virus solution is installed, a quality rating for an installed anti-virus solution, and/or whether the installed anti-virus solution matches the anti-virus solution installed on other clients 115. As a non-limiting example, the overall score may be less for one of the one or more clients 115 that has “Horton” installed when every other device has “McDunfee” installed because uniformity of virus detection in the networked environment may be desired, even if “McDunfee” is rated lower than “Horton”. As shown in user interface 200, a client 115 named “Carol's β5” may have a low score based at least in part on no anti-virus solution being installed and the device being rooted, whereas a device named “Billy PC” may have a high score based at least in part on a highly rated anti-virus solution being installed, no other risks being detected, and automatic updates being enabled.

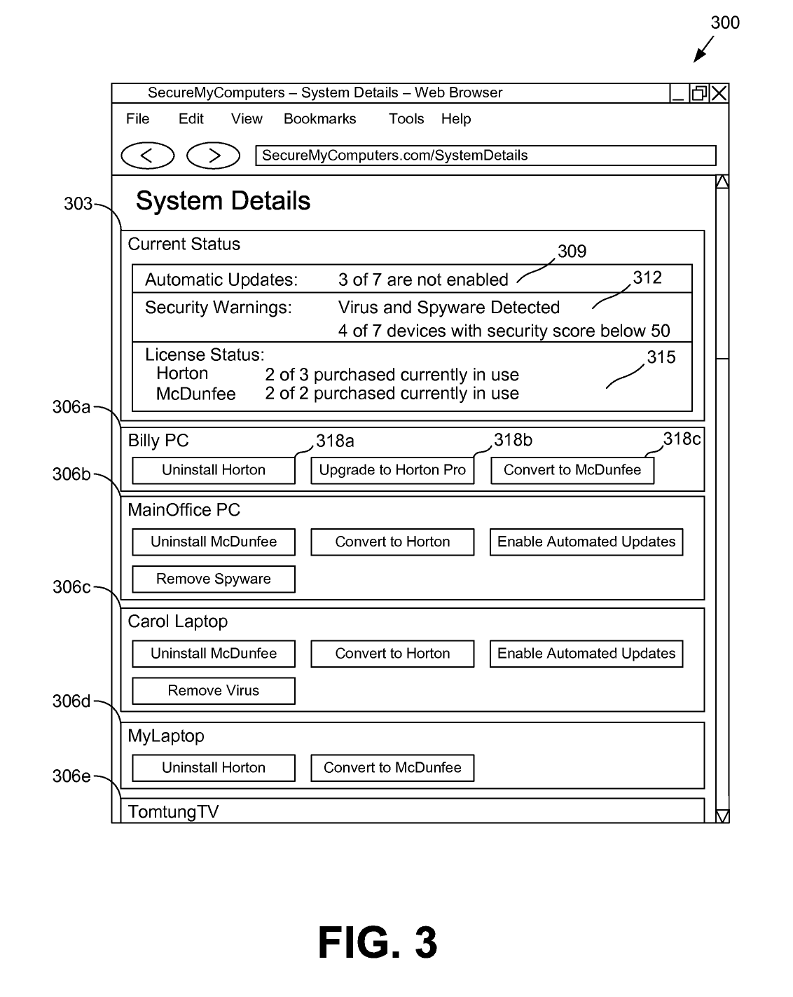

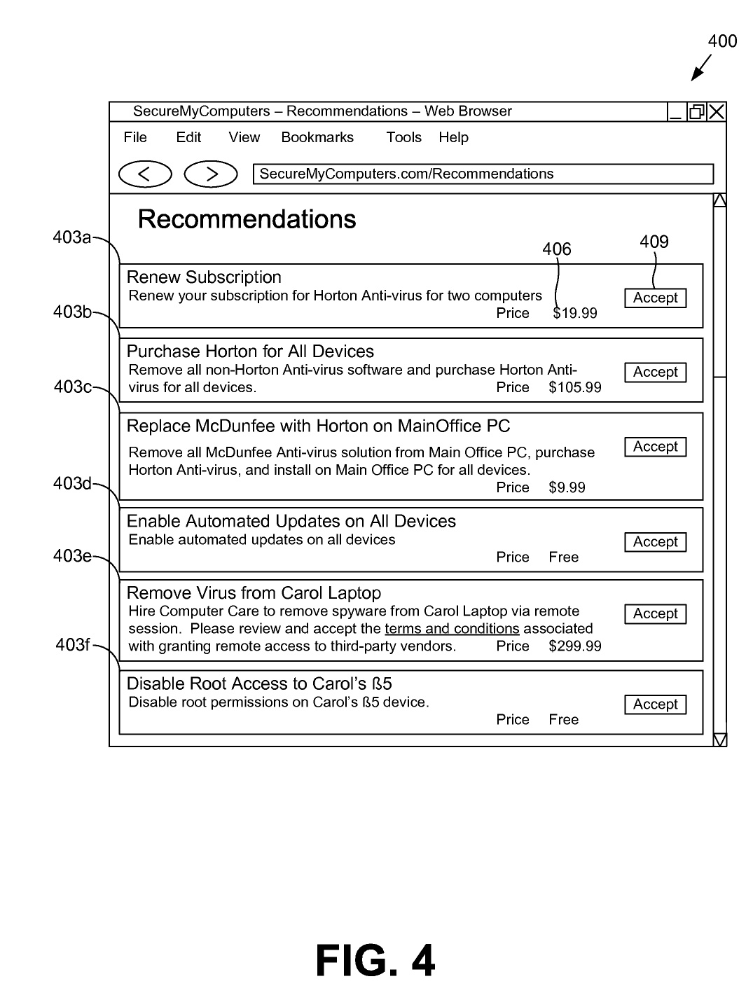

The listing of offers 206 may include pricing for a package of solutions 230 and/or a cost per product 233. The listing of offers 206 may include user interface elements, such as selected user interface element 236 and deselected user interface element 239. The endpoint analysis engine 121 may initiate the purchase of one or more selected offers in response to receiving an indication of a selection of the purchase button 209. The endpoint analysis engine 121 may render another user interface displaying more options for the user, such as the example user interfaces shown in FIGS. 3 and 4, in response to receiving an indication of a selection of the more options button 212.

With reference to FIG. 3, shown is an example drawing of a user interface 300 rendered by a client 115 in the networked environment 100 of FIG. 1 according to various embodiments of the present disclosure. The user interface 300 is shown as a web page from a web server on the computing environment 103 (FIG. 1), referred to as “SecureMyComputers.com”; however, the user interface 300 may be a user interface of a program locally executed on a device, served from network device 112 (FIG. 1), and from another client 115 (FIG. 1). The user interface 300 may include a current status 303 for the one or more clients 115, and one or more detailed options 306a-306e. The detailed options 306a-306e may individually correspond to one or more clients 115. The current status 303 may include a status of automatic updates 309 on the one or more clients 115, information regarding security warnings 312 on the one or more clients 115, and/or license status 315 for products and/or services purchased by a user.

The one or more detailed options 306a-306e may include one or more buttons 318a-318c configured to perform an action. For example, button 318a may cause “Horton” anti-virus to be uninstalled on a client 115 named “Billy PC,” button 318 may cause “Horton” anti-virus to be upgraded to “Horton” Pro on “Billy PC,” and button 318c may cause “Horton” to be uninstalled on “Billy PC” and “McDunfee” to be installed on “Billy PC.” Other buttons may cause spyware to be removed from a client 115, enable automated updates on a client 115, and/or remove a virus from a client 115. The endpoint analysis engine 121 may cause the action in response to receiving an indication of a user interface element being selected by initiating a program to perform the operation, transmitting a request for a third-party to perform the operation, and/or initiating a remote session with a third-party to perform the operation.

With reference to FIG. 4, shown is an example drawing of a user interface 400 rendered by a client 115 in the networked environment 100 of FIG. 1 according to various embodiments of the present disclosure. The user interface 300 is shown as a web page from a web server on the computing environment 103 (FIG. 1), referred to as “SecureMyComputers.com”; however, the user interface 400 may be a user interface of a program locally executed on a device, served from network device 112 (FIG. 1), and from another client 115 (FIG. 1). The user interface 400 may include one or more recommendations, such as recommendations 403a-403f. The one or more recommendations 403a-403f may be ordered based in part on a respective priority individually assigned to each of the one or more recommendations 403a-403f. The one or more recommendations 403a-403f may include a price 406 and a user interface element 409 to initiate and/or accept the recommendation. Selecting user interface element 409 may add a product or service associated with the recommendation to a shopping cart and/or initiate the purchase of the product or service associated with the recommendation.

When the price of the product or service associated with the recommendation is set to free or zero, selecting the user interface element 409 may skip purchasing the product or service and cause an action to be taken corresponding to the recommendation. For example, in response to receiving an indication of acceptance of the recommendation 403d, the endpoint analysis engine 121 may cause any clients 115 with automatic updates disabled to enable automatic updates. As another example, in response to receiving an indication of acceptance of the recommendation 403f, the endpoint analysis engine 121 may cause root permissions on a client 115 named “Carol's β5” to be revoked. As yet another example, in response to receiving an indication of acceptance of the recommendation 403b, the endpoint analysis engine 121 may charge a credit card associated with a user for $105.99 and initiate the removal of “McDunfee” from any of the one or more clients 115 currently running “McDunfee,” while installing “Horton” on any of the one or more clients that do not currently have “Horton” installed. A recommendation, such as recommendation 403e, may have a set of terms and conditions associated with the recommendation and selecting a user interface element to indicate acceptance of the recommendation may also indicate acceptance of the terms and conditions associated with the recommendation.

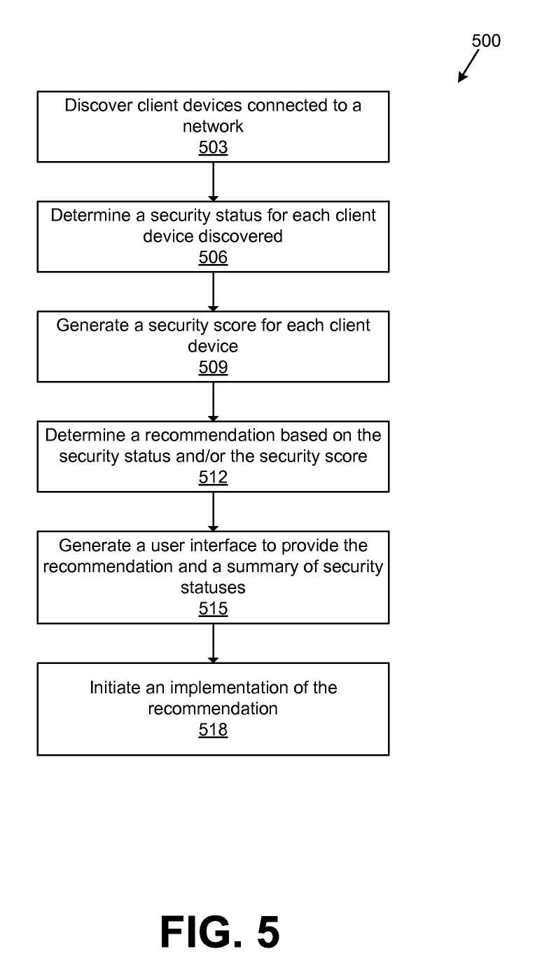

Referring next to FIG. 5, shown is an endpoint analysis process 500 illustrated as a flowchart that provides one example of the operation of a portion of the endpoint analysis engine 121 (FIG. 1) according to various embodiments. It is understood that the flowchart of FIG. 5 provides merely an example of the many different types of functional arrangements that may be employed to implement the operation of the portion of the endpoint analysis engine 121 as described herein. As an alternative, the flowchart of FIG. 5 may be viewed as depicting an example method implemented in one or more of the computing environment 103 (FIG. 1), network device 112 (FIG. 1), or one or more clients 115 (FIG. 1) according to one or more embodiments.

Beginning with box 503, the endpoint analysis engine 121 may discover one or more clients 115 that are connected to networking device 112. For example, the endpoint analysis engine 121 may transmit a broadcast request to all devices on the network, scan a list of devices from a DHCP address assignment table, and/or iteratively poll IP addresses from a starting address to an ending address. In box 506, the endpoint analysis engine 121 may perform a series of security status checks for each of the one or more clients 115. For example, the endpoint analysis engine may query one or more clients 115 connected to network device 112 to request a check be performed on each respective client to determine a security status.

Turning to box 509, the endpoint analysis engine 121 may generate a security score for each of the one or more clients 115 based in part on the determined security status. The endpoint analysis engine 121 may skip generating a score for one or more clients 115 that a security status was unavailable. The score may be an overall score for security on the device. The score may be calculated based in part on the determined security status and/or one or more product offerings from one or more third-party vendors 106. In box 512, the endpoint analysis engine 121 may generate one or more recommendations based at least in part on a generated the security status and/or security score. The one or more recommendations may include installing, replacing, or uninstalling an anti-virus solution, enabling automated updates, disabling sharing for certain clients 115, and disabling rooting of a device. For example, the endpoint analysis engine 121 may recommend disabling sharing devices, pictures, and documents with any clients 115 with a score failing to meet a predetermined threshold.

In box 515, the endpoint analysis engine 121 may generate a user interface to provide the recommendation and/or a summary of the security statuses for at least one of the one or more clients 115. As a non-limiting example, the endpoint analysis engine 121 may generate one or more of user interfaces 200 (FIG. 2), 300 (FIG. 3), and/or 400 (FIG. 4). In box 518, the endpoint analysis engine 121 may initiate an implementation associated with the recommendation. For example, the endpoint analysis engine 121 may cause an implementation associated with the recommendation to occur.

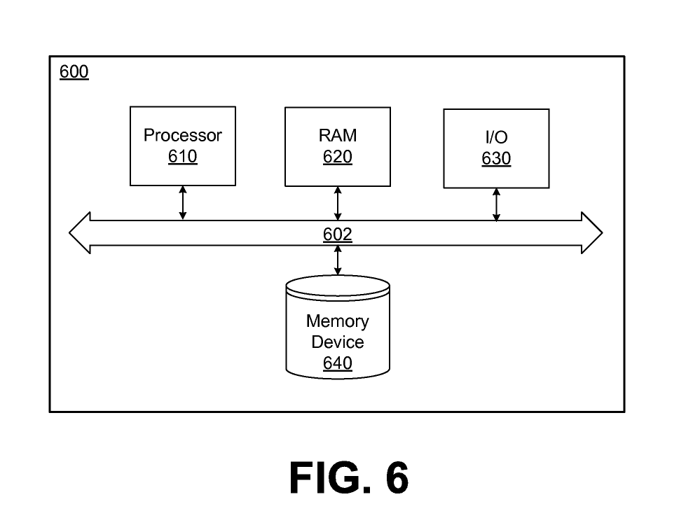

With reference to FIG. 6, shown is a schematic block diagram of a computing device in the computing environment 103, the third-party vendor 106, the networking device 112, and/or each of the one or more clients 115, according to an embodiment of the present disclosure. The computing environment 103, the third-party vendor 106, the networking device 112, and/or each of the one or more clients 115 may include one or more computing devices. Each computing device may include at least one processor circuit, for example, having a processor 610, RAM 620, I/O 630, and a memory 640, each of which may be coupled to a local interface 602. To this end, each computing device may comprise, for example, at least one server computer or like device. The local interface 602 may comprise, for example, a data bus with an accompanying address/control bus or other bus structure as can be appreciated.

Stored in the memory 640 are both data and several components that are executable by the processor 610. In particular, stored in the memory 640 and executable by the processor 610 are endpoint analysis engine 121, and potentially other applications. Also stored in the memory 640 may be a data store 118 and other data. In addition, an operating system may be stored in the memory 640 and executable by the processor 610.

It is understood that there may be other applications that are stored in the memory 640 and are executable by the processor 610 as can be appreciated. Where any component discussed herein is implemented in the form of software, any one of a number of programming languages may be employed such as, for example, C, C++, C#, Objective C, Java®, JavaScript®, Perl, PHP, Visual Basic®, Python®, Ruby, Flash®, or other programming languages.

A number of software components are stored in the memory 640 and are executable by the processor 610. In this respect, the term “executable” means a program file that is in a form that can ultimately be run by the processor 610. Examples of executable programs may be, for example, a compiled program that can be translated into machine code in a format that can be loaded into a random access portion of the memory 640 and run by the processor 610, source code that may be expressed in proper format such as object code that is capable of being loaded into a random access portion of the memory 640 and executed by the processor 610, or source code that may be interpreted by another executable program to generate instructions in a random access portion of the memory 640 to be executed by the processor 610, etc. An executable program may be stored in any portion or component of the memory 640 including, for example, random access memory (RAM), read-only memory (ROM), hard drive, solid-state drive, USB flash drive, memory card, optical disc such as compact disc (CD) or digital versatile disc (DVD), floppy disk, magnetic tape, or other memory components.

The memory 640 is defined herein as including both volatile and nonvolatile memory and data storage components. Volatile components are those that do not retain data values upon loss of power. Nonvolatile components are those that retain data upon a loss of power. Thus, the memory 640 may comprise, for example, random access memory (RAM), read-only memory (ROM), hard disk drives, solid-state drives, USB flash drives, memory cards accessed via a memory card reader, floppy disks accessed via an associated floppy disk drive, optical discs accessed via an optical disc drive, magnetic tapes accessed via an appropriate tape drive, and/or other memory components, or a combination of any two or more of these memory components. In addition, the RAM may comprise, for example, static random access memory (SRAM), dynamic random access memory (DRAM), or magnetic random access memory (MRAM) and other such devices. The ROM may comprise, for example, a programmable read-only memory (PROM), an erasable programmable read-only memory (EPROM), an electrically erasable programmable read-only memory (EEPROM), or other like memory device.

Also, the processor 610 may represent multiple processors 610 and/or multiple processor cores and the memory 640 may represent multiple memories 640 that operate in parallel processing circuits, respectively. In such a case, the local interface 602 may be an appropriate network that facilitates communication between any two of the multiple processors 610, between any processor 610 and any of the memories 640, or between any two of the memories 640, etc. The local interface 602 may comprise additional systems designed to coordinate this communication, including, for example, performing load balancing. The processor 610 may be of electrical or of some other available construction.

Although endpoint analysis engine 121, and other various systems described herein, may be embodied in software or code executed by general purpose hardware as discussed above, as an alternative the same may also be embodied in dedicated hardware or a combination of software/general purpose hardware and dedicated hardware. If embodied in dedicated hardware, each can be implemented as a circuit or state machine that employs any one of or a combination of a number of technologies. These technologies may include, but are not limited to, discrete logic circuits having logic gates for implementing various logic functions upon an application of one or more data signals, application specific integrated circuits (ASICs) having appropriate logic gates, field-programmable gate arrays (FPGAs), or other components, etc. Such technologies are generally well known by those skilled in the art and, consequently, are not described in detail herein.

The flowchart of FIG. 5 shows the functionality and operation of an implementation of portions of the endpoint analysis engine 121. If embodied in software, each block may represent a module, segment, or portion of code that comprises program instructions to implement the specified logical function(s). The program instructions may be embodied in the form of source code that comprises human-readable statements written in a programming language or machine code that comprises numerical instructions recognizable by a suitable execution system such as a processor 610 in a computer system or other system. The machine code may be converted from the source code, etc. If embodied in hardware, each block may represent a circuit or a number of interconnected circuits to implement the specified logical function(s).

Although the flowchart of FIG. 5 shows a specific order of execution, it is understood that the order of execution may differ from that which is depicted. For example, the order of execution of two or more blocks may be scrambled relative to the order shown. Also, two or more blocks shown in succession in FIG. 5 may be executed concurrently or with partial concurrence. Further, in some embodiments, one or more of the blocks shown in FIG. 5 may be skipped or omitted. In addition, any number of counters, state variables, warning semaphores, or messages might be added to the logical flow described herein, for purposes of enhanced utility, accounting, performance measurement, or providing troubleshooting aids, etc. It is understood that all such variations are within the scope of the present disclosure.

Also, any logic or application described herein, including endpoint analysis engine 121 that comprises software or code can be embodied in any non-transitory computer-readable medium for use by or in connection with an instruction execution system such as, for example, a processor 610 in a computer system or other system. In this sense, the logic may comprise, for example, statements including instructions and declarations that can be fetched from the computer-readable medium and executed by the instruction execution system. In the context of the present disclosure, a “computer-readable medium” can be any medium that can contain, store, or maintain the logic or application described herein for use by or in connection with the instruction execution system.

The computer-readable medium can comprise any one of many physical media such as, for example, magnetic, optical, or semiconductor media. More specific examples of a suitable computer-readable medium would include, but are not limited to, magnetic tapes, magnetic floppy diskettes, magnetic hard drives, memory cards, solid-state drives, USB flash drives, or optical discs. Also, the computer-readable medium may be a random access memory (RAM) including, for example, static random access memory (SRAM) and dynamic random access memory (DRAM), or magnetic random access memory (MRAM). In addition, the computer-readable medium may be a read-only memory (ROM), a programmable read-only memory (PROM), an erasable programmable read-only memory (EPROM), an electrically erasable programmable read-only memory (EEPROM), or other type of memory device.

Further, any logic or application described herein, including endpoint analysis engine 121, may be implemented and structured in a variety of ways. For example, one or more applications described may be implemented as modules or components of a single application. Further, one or more applications described herein may be executed in shared or separate computing devices or a combination thereof. For example, a plurality of the applications described herein may execute in the same computing device, or in multiple computing devices in the same computing environment 103. Additionally, it is understood that terms such as “application,” “service,” “system,” “engine,” “module,” and so on may be interchangeable and are not intended to be limiting.

Disjunctive language such as the phrase “at least one of X, Y, or Z,” unless specifically stated otherwise, is otherwise understood with the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

It should be emphasized that the above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

Therefore, the following is claimed:

1. A system, comprising:
a data store; and
at least one computing device in communication with the data store, the at least one computing device being configured to at least:
determine a respective security status for each of a plurality of client devices controlled by an entity;
determine at least one recommendation based at least in part on the respective security statuses of at least two of the plurality of client devices; and
generate a user interface providing the at least one recommendation and a summary of the respective security statuses for the plurality of client devices.

2. The system of claim 1, wherein the user interface includes an overall risk score for the entity.

3. The system of claim 1, wherein the user interface includes a corresponding plurality of options to selectively enable scanning for presence of a plurality of predetermined content types upon the plurality of client devices by an endpoint analysis engine executed by the at least one computing device.

4. The system of claim 1, wherein the at least one computing device is further configured to at least discover at least one of the plurality of client devices by virtue of its connection to an internal network.

5. The system of claim 1, wherein the at least one recommendation comprises a recommendation to install a particular anti-virus solution upon at least one of the plurality of client devices.

6. The system of claim 1, wherein the at least one recommendation comprises a recommendation to renew a subscription to a particular anti-virus solution upon at least one of the plurality of client devices.

7. The system of claim 1, wherein the at least one recommendation comprises a recommendation to replace an installed anti-virus solution of at least one of the plurality of client devices with a different anti-virus solution.

8. The system of claim 1, wherein the at least one recommendation comprises a recommendation to enable an automatic update feature upon at least one of the plurality of client devices.

9. The system of claim 1, wherein the at least one recommendation comprises a recommendation to engage a support provider to perform a manual remote support action upon at least one of the plurality of client devices.

10. The system of claim 1, wherein determining the respective security status for each of the plurality of client devices controlled by the entity further comprises causing the at least one computing device to at least poll each of the plurality of client devices for security status information.

11. The system of claim 1, wherein the at least one computing device is further configured to at least obtain a corresponding competitive offer from each of a plurality of security solution providers for installing a respective security solution upon each of the plurality of client devices.

12. The system of claim 1, wherein the at least one computing device is further configured to at least initiate an automated task in order to implement the at least one recommendation.

13. The system of claim 12, wherein the automated task comprises automatically installing a security solution upon at least one of the plurality of client devices.

14. The system of claim 12, wherein the automated task comprises automatically enabling automatic updates for at least one of the plurality of client devices.

15. The system of claim 1, wherein the respective security status includes whether an automatic update feature is enabled.

16. The system of claim 1, wherein the respective security status includes whether a particular client device of the plurality of client devices is rooted.

17. The system of claim 1, wherein the respective security status includes a subscription status of an installed security solution.

18. The system of claim 1, wherein the entity is a household, and each of the plurality of client devices are configured to be coupled to a household network.

19. The system of claim 1, wherein the entity is a small business.

20. The system of claim 1, wherein the at least one recommendation comprises a plurality of recommendations, and the at least one computing device is further configured to at least assign a respective priority to each of the plurality of recommendations based at least in part on one or more factors, wherein the one or more factors includes a respective cost to implement each of the plurality of recommendations.
